(19) United States
(12) Patent Application Publication
(10) Pub. No.: US 2025/0251332 A1
(43) Pub. Date: Aug. 7, 2025

(54) SYSTEM AND METHOD FOR IMPEDANCE-BASED ANALYSIS OF BIOLOGICAL ENTITIES

(71) Applicant: SEED BIOSCIENCES SA, Epalinges (CH)

(72) Inventors: Audrey BERGER, Nyon (CH); David BONZON, Puidoux (CH); Georges MULLER, Lausanne (CH); Philippe RENAUD, Préverenges (CH)

(21) Appl. No.: 18/856,010

(22) PCT Filed: Apr. 12, 2023
(86) PCT No.: PCT/IB2023/053730

§ 371 Date: Oct. 10, 2024

(30) Foreign Application Priority Data
Apr. 12, 2022 (WO) PCT/IB2022/053421

(51) Int. Cl. G01N 15/12; G01N 15/10; G01N 15/14

(52) U.S. Cl. CPC G01N 15/12; G01N 15/14; G01N 2015/1006; G01N 2015/1028

(57) ABSTRACT

The present invention generally belongs to the fields of medtech, labtech and impedance analysis. In particular, the present invention pertains methods and apparatuses for identification and isolation of biological entities such as cells trough impedance analyses.

### CORRESPONDING APPLICATION

The present application claims priority to the earlier PCT International Application PCT/IB2022/053421 filed on Apr. 12, 2022, the content of the earlier applications being incorporated by reference in its entirety in the present application.

### TECHNICAL FIELD

The present invention generally belongs to the fields of medtech, labtech and impedance analysis. In particular, the present invention pertains methods and apparatuses for identification and isolation of biological entities such as cells trough impedance analyses.

### BACKGROUND ART

Cellular function is determined by a myriad of biochemical reactions and biophysical processes coordinated in time and space by cellular control mechanisms. Living cells have many interesting properties: they offer miniature size, biological specificity, surface binding capability, self-replication, multivariate detection, and other benefits. Moreover, cells can be used to produce therapeutic proteins, as diagnostic tool or to monitor complex diseases and as therapeutic agents. Their engineering and/or selection requires rapid characterization methods. While current optical and chemical detection techniques can effectively analyse biological systems, a number of disadvantages restrict their versatility. As examples: most samples must be chemically altered prior to analysis, and photobleaching can place a time limit on optically probing fluorophore-tagged samples. Impedance spectroscopy-based techniques provide solutions to many such problems, as they can probe a sample and its chemical environment directly over a range of time scales, without requiring any chemical modifications.

Single cell isolation is a key process in many fields such as cell line development and precision medicine for example. Cellular characterization at single cell level is however difficult to perform without affecting viability and often necessitate labelling. In recent years, impedance spectroscopy, a label free technology, has emerged to analyse single cell properties.

In a similar way, Impedance Flow Cytometry (IFC) rapidly characterizes a large amount of cells at the single-cell level. The readout depends solely on the electric properties of cells, thus no labelling is required and sample preparation is minimal. This makes IFC exceptionally well-suited for applications that require a quick time-to-result, field measurements and in-line analytics.

Impedance-based single cell analysis systems, also known as Coulter counters, represent a well-established method for counting and sizing any kind of cells and particles. This technology, however, was until recently not suitable for cell characterization applications, for which advanced and powerful fluorescence-based cell analysis and sorting devices (FACS) provided the gold standard in research and clinical laboratories, having however several limitations such as the need of cell labelling, the necessity of a minimum amount of cells for performing the analysis and the impact on cell viability, in addition of its need to be calibrated, cleaned and sterilized upon each use.

Instruments based on Coulter Principle and using a single frequency impedance measurements to determine the cellular size are available for blood cell analysis. Despite those instruments are good to distinguish between cells population based on their size, they can't measure other dielectric properties. What is desired is a method and system that can perform broad-band impedance characterizations of biological entities to enable superior differentiation via features in their impedance spectra and allowing to simultaneously isolate and retrieve the biological entity. The present invention addresses this and other limitations and drawbacks of the state of the art approaches.

### SUMMARY OF INVENTION

In order to address and overcome at least some of the above-mentioned drawbacks of the prior art solutions, the present inventors developed a new method and system to analyse biological samples and biological entities such as cells through impedance means, having improved features and capabilities in terms of identification and possible isolation of the suitable targets.

According to the present invention there is provided a method for identifying a single biological entity in a biological entities population according to claim 1.

Accordingly, in one aspect of the invention, a method for identifying a single biological entity in a biological entities population is provided, the single biological entity producing a different level of a target biological entity product compared to a standard reference biological entity or biological entities population, said method comprising the steps of:
a) obtaining a biological entity impedance value of said single biological entity at at least one frequency comprised between 10 KHz and 20 MHz; and
b) comparing said biological entity impedance value to the biological entity impedance value of a standard reference biological entity or biological entities population
wherein a biological entity impedance value comprises an impedance amplitude and an impedance phase
and wherein an impedance phase shift in the biological entity impedance value of the single biological entity, compared to the biological entity impedance value of the standard reference biological entity or biological entities population, is indicative of a different level of production of the target biological entity product from said single biological entity compared to the standard reference biological entity or biological entities population.

In embodiments, said biological entity impedance value is obtained through a frequency-dependent impedance flow cytometry analysis.

In embodiments, the biological entity impedance value of said single biological entity is obtained at a frequency comprised between 50 KHz and 10 MHz.

In embodiments, the biological entity impedance value of a standard reference biological entity or biological entities population is obtained at a frequency comprised between 50 KHz and 10 MHz.

In embodiments, a biological entity impedance value is obtained at a plurality of frequencies comprised between 50 KHz and 10 MHz.

In embodiments, a biological entity impedance value is estimated by calculating the ratio Re(Z) at f1/Re(Z) at f2, Re(Z) being defined as the real part of the impedance vector, and f1 and f2 being two frequencies wherein f1>f2 (f1 is bigger than f2).

In embodiments, the method comprises isolating said single biological entity before, during—such as simultaneously—or after obtaining a biological entity impedance value.

In embodiments, the single biological entity isolation comprises sorting said single biological entity.

In embodiments, the isolating or sorting step is performed through a Coulter principle-based impedance means.

In embodiments, the target biological entity product is selected from a list comprising a daughter cell, an organelle, growth factor, a protein, a recombinant protein, a peptide, an enzyme, a virus, a bacterial cell, an antibody or any derivative thereof, a platelet, a hormone including steroids or modified steroids, an anti-inflammatory agent, an anti-viral agent, an anti-bacterial agent, a vitamin, a cytokine, a protein receptor, a serum protein, an adhesion molecule, a lipid molecule, a neurotransmitter, a morphogenetic protein, a differentiation factor, polysaccharides, a biological entity matrix protein, a suitable fusion protein of any of the foregoing, a nucleic acid, and any suitable combination of the foregoing.

In embodiments, said single biological entity and said standard reference biological entity are of the same biological entity type.

In embodiments, said standard reference biological entities population is a biological entities population or sub-population comprising said single biological entity.

In embodiments, the method is computer implemented or supervised.

In embodiments, the biological entity impedance value is obtained through the Coulter counter principle.

In embodiments, the biological entity is a cell.

In embodiments, said cell is genetically modified to produce a target cell product.

In embodiments, said target cell product is extracellularly secreted.

Another object of the present invention relates to a system as per claim 18.

Accordingly, in one aspect of the invention, a system is provided comprising:
a) a frequency-dependent impedance analyzer and
b) a data processing apparatus operatively connected to said impedance analyzer, the data processing apparatus comprising a processor and instructions that, when executed by said processor, cause the data processing apparatus to
   obtaining, from the frequency-dependent impedance analyzer, a biological entity impedance value of a single biological entity in a biological entities population, said biological entity impedance value comprising an impedance amplitude and an impedance phase;
   comparing said biological entity impedance value to the biological entity impedance value of a standard reference biological entity or biological entities population; and
   graphically or numerically providing a read-out of said comparison.

In embodiments, said frequency-dependent impedance analyzer is a frequency-dependent impedance flow cytometer.

In embodiments, the frequency-dependent impedance analyzer is configured to operate at at least one frequency comprised between 10 KHz and 20 MHz, such as between 0.5 and 10 MHz, or between 2 and 8 MHz.

In embodiments, the processor comprises instructions to perform a biological entity impedance value estimation of said single biological entity by calculating the ratio Re(Z) at f1/Re(Z) at f2, Re(Z) being defined as the real part of the impedance vector, and f1 and f2 being two frequencies wherein f1>f2 (f1 is bigger than f2).

In embodiments, the flow cytometer is configured to isolate or sort said single biological entity through a Coulter principle-based impedance means.

Further embodiments of the present invention are defined by the appended claims.

The above and other objects, features and advantages of the herein presented subject-matter will become more apparent from a study of the following description with reference to the attached figures showing some preferred aspects of said subject-matter.

### BRIEF DESCRIPTION OF DRAWINGS

FIG. 1 shows a vectorial representation of impedance in rectangular coordinate;

FIG. 2 shows impedance flow cytometry analyses of CHO cells producing at high levels (HP) or not producing (NP) at detectable level the therapeutic protein etanercept. Density dot plots (A) and the density plot (B) of HP and NP indicates a shift in the phase for the HP compared to the NP cells;

FIG. 3 shows impedance flow cytometry analyses of transfected CHO cells expressing the therapeutic protein etanercept (TNFR-Fc) at different levels wherein a difference in phase between HP and MP or NP can be observed using impedance flow cytometry at 8 MHz and 2 MHZ;

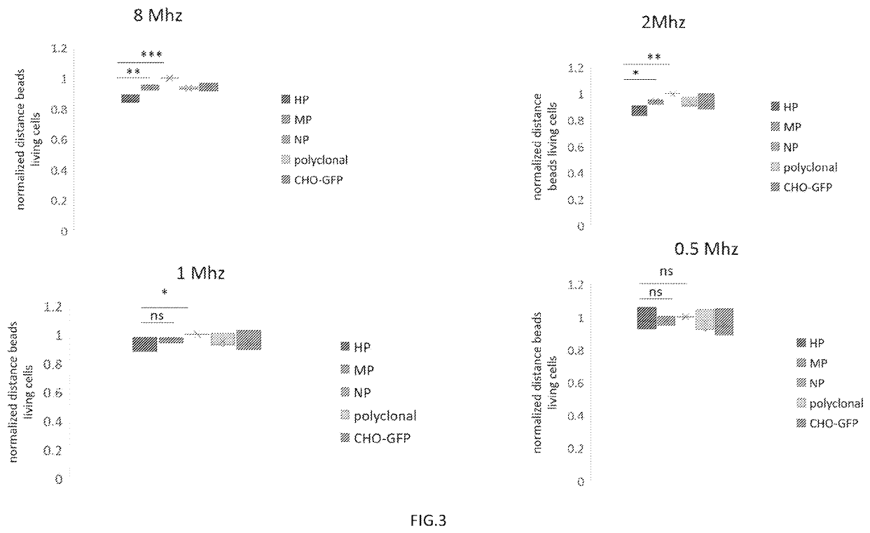

FIG. 4 shows impedance flow cytometry analyses of transfected CHO cells expressing the therapeutic protein etanercept (TNFR-Fc) at different levels wherein of a higher internal standard deviation Re(Z)@8 MHz/Re(Z)@0.5 MHz is observed for polyclonal cells; and

FIG. 5 shows impedance flow cytometry analyses of transfected CHO cells expressing the therapeutic protein etanercept (TNFR-Fc) at different levels wherein vector distance in the complex plan between HP and MP or NP can be observed.

FIG. 6 shows a flow-chart of an embodiment of the method described in the present disclosure.

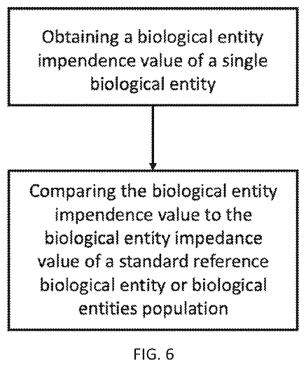

### DETAILED DESCRIPTION OF THE INVENTION

The subject-matter described in the following will be clarified by means of a description of those aspects which are depicted in the drawings. It is however to be understood that the scope of protection of the invention is not limited to those aspects described in the following and depicted in the drawings; to the contrary, the scope of protection of the invention is defined by the claims. Moreover, it is to be understood that the specific conditions or parameters described and/or shown in the following are not limiting of the scope of protection of the invention, and that the terminology used herein is for the purpose of describing particular aspects by way of example only and is not intended to be limiting.

Unless otherwise defined, technical and scientific terms used herein have the same meaning as commonly understood by one of ordinary skill in the art to which this invention belongs. Further, unless otherwise required by the context, singular terms shall include pluralities and plural terms shall include the singular. The methods and techniques of the present disclosure are generally performed according to conventional methods well known in the art and as described in various general and more specific references that are cited and discussed throughout the present specification unless otherwise indicated. Further, for the sake of clarity, the use of the term “about” is herein intended to encompass a variation of +/−10% of a given value.

Non-limiting aspects of the subject-matter of the present disclosure will be described by way of example with reference to the accompanying figures, which are schematic and are not intended to be drawn to scale. For purposes of clarity, not every component is labelled in every figure, nor is every component of each aspect of the invention shown where illustration is not necessary to allow those of ordinary skill in the art to understand the invention.

The following description will be better understood by means of the following definitions.

As used in the following and in the appended claims, the singular forms “a”, “an” and “the” include plural referents unless the context clearly dictates otherwise. Also, the use of “or” means “and/or” unless stated otherwise. Similarly, “comprise”, “comprises”, “comprising”, “include”, “includes” and “including” are interchangeable and not intended to be limiting. It is to be further understood that where for the description of various embodiments use is made of the term “comprising”, those skilled in the art will understand that in some specific instances, an embodiment can be alternatively described using language “consisting essentially of” or “consisting of.”

In the frame of the present disclosure, the expression “operatively connected” and similar reflects a functional relationship between the several components of a device or a system among them, that is, the term means that the components are correlated in a way to perform a designated function. The “designated function” can change depending on the different components involved in the connection. Likewise, any two components capable of being associated can also be viewed as being “operably couplable,” to each other to achieve the desired functionality. A person skilled in the art would easily understand and figure out what are the designated functions of each and every component of the device or the system of the invention, as well as their correlations, on the basis of the present disclosure.

As used herein, a “biological entity” is a biological unit of interest selected from a cell (including eukaryotic and prokaryotic cells), a virus and an organelle (including e.g. mitochondria).

A “target biological entity product” is any chemical or biological analytical sample obtainable from a biological entity. A target biological entity product according to the present disclosure typically represents a (macro) molecule of interest, and a method and a system according to the invention is set up in order to identify and possibly isolate a biological entity showing peculiar features in relation to the presence, absence, production, ablation, production level, type, isomeric form and the like of the target product. As a way of example, a target biological entity product may be a so-called “bioactive agent”, “bioactive molecule”, “bioactive compound” or “therapeutic agent”, that is, any active agent that is biologically active, i.e. having an effect upon a living organism, tissue, or cell, and a method and a system according to the invention is set up in order to identify and possibly isolate a cell characterized by its ability to express, produce, secrete, ablate etc. said bioactive molecule.

Accordingly, in embodiments of the invention, the target biological entity product, depending on the needs and circumstances, is selected from a non-exhaustive list comprising a daughter cell, an organelle, a growth factor, a protein, a recombinant protein, a peptide, an enzyme, a virus, a bacterial cell, an antibody or any derivative thereof (such as e.g. multivalent antibodies, multispecific antibodies, scFvs, bivalent or trivalent scFvs, triabodies, minibodies, nanobodies, diabodies etc.), a hormone including steroids or modified steroids, an anti-inflammatory agent, an anti-viral agent, an anti-bacterial agent, a vitamin, a cytokine, a spore, a platelet, a protein receptor, a serum protein, an adhesion molecule, a lipid molecule, a neurotransmitter, a morphogenetic protein, a differentiation factor, polysaccharides, a cell matrix protein, a suitable fusion protein of any of the foregoing, any type of nucleic acid, such as e.g. DNA, RNA, siRNA, miRNA and the like, any suitable functional fragment, suitable fusion protein or derivative of the foregoing and any suitable combination of the foregoing. A “functional fragment” is herein meant any portion of a molecule that is able to exert its physiological/pharmacological activity. For example, a functional fragment of an antibody could be an Fc region, an Fv region, a Fab/F(ab′)/F(ab′) 2 region and so forth.

When referring to a “daughter cell”, according to the present disclosure it is herein meant that a target biological entity product may be one or more cells deriving from another cell (“progenitor cell”). In this context, as a way of non-limiting example, the progenitor cell may be analyzed and selected on the basis of the present impedance-based method to be a suitable cell for production of daughter cells; for instance, impedance analysis of a progenitor cell may identify the ability of said progenitor to give rise to a suitable progeny of daughter cells, thereby distinguish it from other progenitor cells, possibly in a same cell population or sub-population. This classification can be particularly useful in contexts where stem cells are involved, and the method and system according to the invention may be employed to label, identify or categorize e.g. stem cell-producing progenitor cells.

The method of the invention aims at identifying a single biological entity in a biological entities population, the single biological entity producing a different level of a target biological entity product compared to a standard reference biological entity or biological entities population. For “standard reference biological entity” it is herein meant a biological entity according to the present disclosure that is used as a reference criterion for comparison and/or calibration in the present method. The standard reference biological entity may be selected in advance and may also be part of a database of standard references, or it may be an internal standard selected during the implementation of the method of the invention, for instance as a reference cell in a cell population, as a sub-population or as an entire population of cells.

A different level of a target biological entity product may be evaluated, depending on the circumstances, on the basis of the absolute amount of a target product, a relative amount of a target product, the expression of a target product, the concentration of a target product and the like. For example, a different level of a target RNA product in a cell compared to a standard reference cell may be an overexpression or ablation of said RNA product in a cell vis-à-vis the chosen standard of reference.

The method of the invention foresees at least the steps of:
a) obtaining a biological entity impedance value of said single biological entity at at least one frequency comprised between 10 KHz and 20 MHZ; and
b) comparing said biological entity impedance value to the biological entity impedance value of a standard reference biological entity or biological entities population
wherein a biological entity impedance value comprises an impedance amplitude and an impedance phase
and wherein an impedance phase shift in the biological entity impedance value of the single biological entity compared to the biological entity impedance value of the standard reference biological entity or biological entities population is indicative of a different level of production of the target biological entity product from said single biological entity compared to the standard reference biological entity or biological entities population.

It has been assessed by the present inventors that, through the analysis of impedance values obtained in a suitable range of frequencies, it is possible to discriminate single cells compared to a standard or within a cell population for their ability to produce various levels of products of interest.

For instance, the invention is particularly suitable, and may therefore be used, for the identification of single cells with low, medium or high-producing capability with regards to a target protein, such as a therapeutic agent. In this way, the so-identified single cells may be isolated and used for instance to build up cell clones as a first step in a manufacturing process of therapeutic agents, such as clonal antibodies, fusion proteins etc. However, the invention is not limited whatsoever to cells and proteinaceous therapeutic agents, but other kind of target products, starting biological entities and the like are possible as well.

In the method, obtaining a biological entity impedance value of a single biological entity, such as a cell, may be performed in many different ways; for example, the impedance value of interest, that always comprises at least an impedance amplitude and an impedance phase, may be extrapolated or obtained from a database, or may be obtained through a frequency-dependent impedance analyzer, a frequency-dependent impedance flow cytometry analysis, or a Coulter principle-based impedance means, to cite some. Impedance flow cytometry (IFC) uses label-free impedance-based readings for rapid and multiparametric analysis of single cells, and it may therefore be considered as a tool of excellence in the frame of the invention. Suitable instruments to perform a frequency-dependent impedance analysis include impedance flow cytometers such as the Ampha cell analyzers from Amphasys or the DispenCell impedance-based single cell dispenser from SEED Biosciences.

In any embodiments of the invention, a biological entity impedance value of a single biological entity such as a cell is obtained at at least one frequency comprised between 10 KHz and 20 MHz. Suitable frequencies are for instance 50 kHz, 100 kHz, 250 kHz, 500 KHz, 1 MHZ, 2 MHz, 5 MHZ, 8 MHz, 10 MHz or 20 MHz. Suitable frequency ranges are for instance between 50 KHz and 10 MHz, between 250 kHz and 10 MHz, between 250 kHz and 2 MHz, between 2 MHz and 10 MHz, between 1 MHz and 5 MHz or between 2 MHz and 8 MHz. These frequencies and frequency ranges are applicable for the obtainment of an impedance value of single biological entities of interest, as well as for the obtainment of an impedance value of a standard reference biological entity or biological entities population. In some embodiments, a biological entity impedance value is obtained at a plurality of frequencies, typically comprised between 50 KHz and 10 MHz.

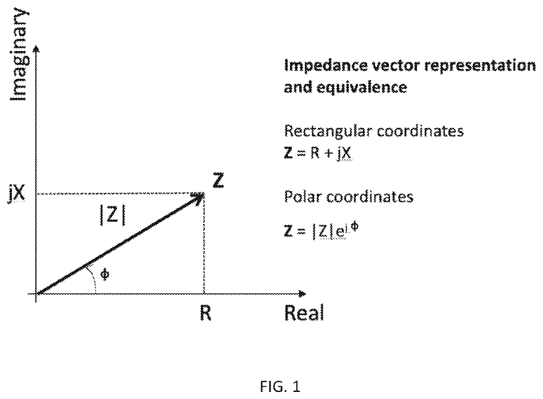

The value measured in IFC is the electric impedance (Z) of biological entities such as cells, which is a complex number consisting of two parts: the resistance (R, the real part of Z) and the reactance (X, the imaginary part of Z), which is frequency dependent. Impedance can be presented on a complex plane as the vector Z. When represented in rectangular coordinates as in FIG. 1, the components of the impedance Z are the resistance R, which is the real component, and the reactance X, which is the imaginary component that is dependent on frequency. When represented in polar coordinates, the components of the impedance Z are the magnitude |Z|, which is the length of the vector Z, and the phase φ, which is the angle of the vector Z with respect to the real axis.

The state of a cell can be assessed by measuring the impedance at different frequencies. The cell membrane itself acts as an insulator at low frequencies, allowing the determination of cell size. At such frequencies, the cell membrane is polarized and hinders the flow of the electrical current. The charge distribution of ions or charged molecules on each side of the cell changes when an oscillating electric field is applied to the cell. Hence at higher frequency, a current is circulating through the cell membrane. Thus the intracellular properties can be measured as well.

Up to the inventors' knowledge, however, none of the state of the art systems and methods for assessing the characteristics of a biological entity such as a cell has ever been adapted and tailored to determine a different level of production of a target product from a single biological entity compared to a standard reference while at the same time being able to directly isolate said single biological entity based on the measured parameters. The present invention address and solves this drawback.

Once the impedance values of both the single biological entity under analysis and of the standard reference obtained, in a successive step a comparison between those is done. In particular, a comparison between the impedance phases is performed, a shift in said impedance phase being indicative of a different level of production of the target biological entity product from said single biological entity compared to the standard reference biological entity or biological entities population.

In advantageous embodiments of the present method, the single biological entity and the standard reference biological entity are of the same biological entity type. For instance, both the single biological entity and the standard reference biological entity are cells, preferably of the same cell line. Additionally, in another advantageous embodiment, the single biological entity, e.g. a single cell, is compared in the method with a standard reference biological entities population or sub-population comprising the same. In this embodiment, a cell population or sub-population is selected as a reference standard based on previously defined impedance parameters, and impedance values of the (sub-) population are normalized around e.g. an average reference impedance signal indicative of certain target features of the (sub-) population. A single cell of interest is therefore detected based on an impedance-based shift vis-à-vis said normalized reference impedance signal, thereby allowing the identification of a difference, in the single cell under analysis, of a different level in the product of a target product.

In a particularly advantageous embodiment, a biological entity impedance value is estimated by calculating the ratio Re(Z) at f1/Re(Z) at f2, Re(Z) being the real part of the impedance vector, and f1 and f2 being two frequencies wherein f1>f2 (f1 is bigger than f2). As a way of non-limiting examples, f1 may be an operation frequency of 8 MHZ, and f2 may be an operation frequency of 0.5 MHZ, or f1 may be an operation frequency of 8 MHz, and f2 may be an operation frequency of 2 MHz. Advantageously, this configuration allows to acquire in time only two values (i.e. Re(Z) at f1 and Re(Z) at f2) which require an electronic readout considerably simpler.

Selection of high producing clones is the starting point for the commercial development of therapeutic proteins. However high producers are rare events in the heterogeneous population of transfectants and screening for high producing clones is an extensive and time-consuming process. The method of the present invention allows to perform, in embodiments, impedance spectroscopy on a wide frequency spectrum of dispensed cells, and may therefore be used to isolate and characterize clones based on protein production level of each of the selected monoclonal populations/single cells via a correlation between impedance cell parameters and protein level production. Such an early selection could save significant time, money and risk during cell line development.

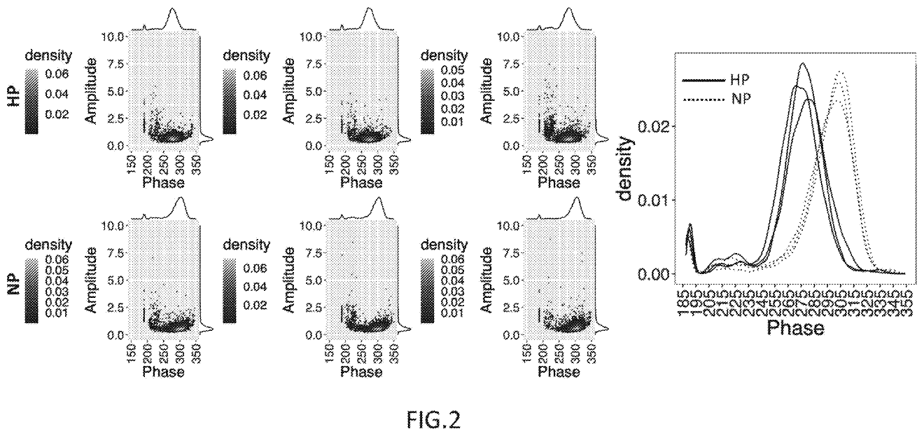

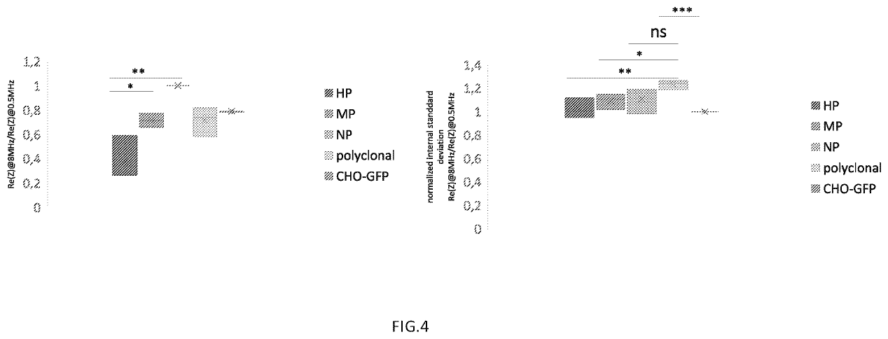

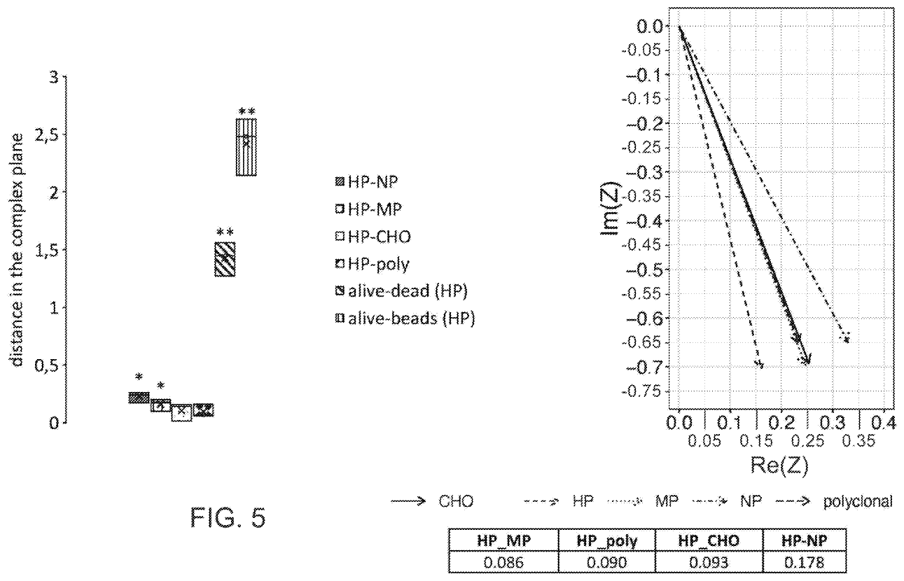

In an attempt to determine whether the level of productivity of TNFR-Fc (Etanercept; target product) in transfected CHO cells can be distinguished using impedance analyses, it has been experimentally confirmed that a difference of impedance phase can be observed between clones expressing at different levels the therapeutic protein TNFR-Fc (FIGS. 2 & 3). Alternatively, clones expressing different levels of therapeutic protein can also be represented and distinguished by their impedance vectors distance in the complex plane as shown in (FIG. 5). In addition, and importantly, it has been further experimentally established that the ratio Re(Z)@8 MHz/Re (Z)@0.5 MHz is a relevant marker for productivity of CHO cells, thereby distinguishing, through the method of the invention, low-, medium- and high-producing CHO cell clones compared to a reference standard represented by GFP expressing CHO cells (FIG. 4).

The above experimental setting is exemplary of embodiments in which the biological entity is a cell genetically modified to produce a target cell product, as it is usually the case in cell line development aiming at establishing a cell line that produces a therapeutic protein in high quality and quantity. Accordingly, in some advantageous embodiments, the target cell product is extracellularly secreted, in order to be subsequently purified for biological drugs manufacturing, for instance.

The identification method of the invention is particularly suitable, therefore, for isolation and/or sorting single cells or otherwise single biological entities based on the recorded impedance values, or even before any impedance analysis takes place. In an advantageous set of embodiments, therefore, the method further envisages isolating a single biological entity before, during or after obtaining a biological entity impedance value. The single biological entity isolation may comprise, in addition, sorting said single biological entity, particularly after the impedance analysis identification of the invention. In a particularly interesting embodiment, said isolation or sorting of single particles/biological entities/cells is performed on a Coulter principle-based impedance means, and additionally the biological entity impedance value may be obtained through the implementation of the Coulter counter principle. As it will be apparent, the entire method may be computer implemented or supervised.

As it will be evident to a person skilled in the art, another objection of the present invention relates to a system comprising:
a) a frequency-dependent impedance analyzer and
b) a data processing apparatus operatively connected to said impedance analyzer, the data processing apparatus comprising a processor and instructions that, when executed by said processor, cause the data processing apparatus to
   obtaining, from the frequency-dependent impedance analyzer, a biological entity impedance value of a single biological entity in a biological entities population, said biological entity impedance value comprising an impedance amplitude and an impedance phase;
   comparing said biological entity impedance value to the biological entity impedance value of a standard reference biological entity or biological entities population; and
   graphically or numerically providing a read-out of said comparison.

Said frequency-dependent impedance analyzer may be a frequency-dependent impedance flow cytometer.

The entire system comprises a data processing apparatus operatively connected with the rest of the system, the data processing apparatus having a processor comprising instructions configured to operate the system to perform a method according to the invention, as defined above. The data processing apparatus of the invention may comprise any suitable device such as computers, smartphones, tablets, voice-activated devices (i.e. smart speakers/voice assistants) and the like.

The data processing apparatus comprises memory storing software modules that provide functionality when executed by the processor. The modules include an operating system that provides operating system functionality for the apparatus. The system, in embodiments that transmit and/or receive data from remote sources, may further include a communication device, such as a network interface card, to provide mobile wireless communication, such as Bluetooth, infrared, radio, Wi-Fi, cellular network, or other next-generation wireless-data network communication. In other embodiments, communication device may provide a wired network connection, such as an Ethernet connection or a modem.

In order to implement the method of the present invention, the frequency-dependent impedance analyzer is configured to operate at at least one frequency comprised between 10 KHz and 20 MHz, such as between 50 KHz and 10 MHz, and in embodiments the processor comprises instructions to perform a biological entity impedance value estimation of said single biological entity by calculating the ratio Re(Z) at f1/Re(Z) at f2, Re(Z) being defined as the real part of the impedance vector, and f1 and f2 being two frequencies wherein f1>f2 (f1 is bigger than f2). As a way of non-limiting examples, f1 may be an operation frequency of 8 MHZ, and f2 may be an operation frequency of 0.5 MHZ, or f1 may be an operation frequency of 8 MHz, and f2 may be an operation frequency of 2 MHz.

Still another aspect of the invention relates to a non-transitory computer readable medium containing a set of instructions that, when executed by data processing apparatus of the system of the invention, cause said data processing apparatus to operate the system to perform a method according to the invention. Further, one aspect of the invention relates to a data processing apparatus comprising the non-transitory computer readable medium of the invention.

In embodiments, the instructions contained by the non-transitory computer readable medium comprise, among others:
instructions for operating the frequency-dependent impedance analyzer;
instructions for operating a comparison between a single biological entity impedance value and the biological entity impedance value of a standard reference biological entity or biological entities population and/or
instructions for obtaining from a database, and comparing between them,
a single biological entity impedance value and the biological entity impedance value of a standard reference biological entity or biological entities population;
instructions for graphically or numerically providing a read-out of said comparison;
instructions for storing impedance value data obtained from the impedance analysis of biological entities;
instructions for enriching a database with impedance value data obtained from the impedance analysis of biological entities.

In a particular embodiment of the invention, the system comprises a flow cytometer configured to isolate or sort said single biological entity through an Impedance Flow Cytometry means or through a Coulter principle-based impedance means. A Coulter principle-based impedance system may be exemplified by the DispenCell robot from SEED Biosciences, described in much details in International Patent Applications WO2016166729, WO2015056176 and WO2018189628, incorporated herein in their entirety by reference.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A method for identifying a single biological entity in a biological entities population, the single biological entity producing a different level of a target biological entity product compared to a standard reference biological entity or biological entities population, said method comprising the steps of:
a) obtaining a biological entity impedance value of said single biological entity at at least one frequency comprised between 10 kHz and 20 MHz; and
b) comparing said biological entity impedance value to the biological entity impedance value of a standard reference biological entity or biological entities population;
wherein a biological entity impedance value comprises an impedance amplitude and an impedance phase; and
wherein an impedance phase shift in the biological entity impedance value of the single biological entity compared to the biological entity impedance value of the standard reference biological entity or biological entities population is indicative of a different level of production of the target biological entity product from said single biological entity compared to the standard reference biological entity or biological entities population.

2. The method of claim 1, wherein said biological entity impedance value is obtained through a frequency-dependent impedance flow cytometry analysis.

3. The method of claim 1, wherein the biological entity impedance value of said single biological entity is obtained at a frequency comprised between 50 kHz and 10 MHz.

4. The method of claim 1, wherein the biological entity impedance value of a standard reference biological entity or biological entities population is obtained at a frequency comprised between 50 kHz and 10 MHz.

5. The method of claim 3, wherein a biological entity impedance value is obtained at a plurality of frequencies comprised between 50 kHz and 10 MHz.

6. The method of claim 1, wherein a biological entity impedance value is estimated by calculating the ratio Re(Z) at f1/Re(Z) at f2, Re(Z) being defined as the real part of the impedance vector, and f1 and f2 being two frequencies wherein f1 is bigger than f2.

7. The method of claim 1, further comprising isolating said single biological entity before, during or after obtaining a biological entity impedance value.

8. The method of claim 7, wherein the single biological entity isolation comprises sorting said single biological entity.

9. The method of claim 7, wherein said isolating or sorting is performed through a Coulter principle-based impedance means or an Impedance Flow Cytometry means.

10. The method of claim 1, wherein said target biological entity product is selected from a list comprising a daughter cell, an organelle, growth factor, a protein, a recombinant protein, a peptide, an enzyme, a virus, a bacterial cell, an antibody or any derivative thereof, a hormone including steroids or modified steroids, an anti-inflammatory agent, an anti-viral agent, an anti-bacterial agent, a vitamin, a cytokine, a platelet, a protein receptor, a serum protein, an adhesion molecule, a lipid molecule, a neurotransmitter, a morphogenetic protein, a differentiation factor, polysaccharides, a biological entity matrix protein, a suitable fusion protein of any of the foregoing, a nucleic acid, and any suitable combination of the foregoing.

11. The method of claim 1, wherein said single biological entity and said standard reference biological entity are of the same biological entity type.

12. The method of claim 1, wherein said standard reference biological entities population is a biological entities population or sub-population comprising said single biological entity.

13. The method of claim 1, wherein said method is computer implemented or supervised.

14. The method of claim 1, wherein the biological entity impedance value is obtained through the Coulter counter principle.

15. The method of claim 1, wherein said biological entity is a cell.

16. The method of claim 15, wherein said cell is genetically modified to produce a target cell product.

17. The method of claim 16, wherein said target cell product is extracellularly secreted.

18. A system comprising:
a) a frequency-dependent impedance analyzer; and
b) a data processing apparatus operatively connected to said impedance analyzer, the data processing apparatus comprising a processor and instructions that, when executed by said processor, cause the data processing apparatus to:
obtaining, from the frequency-dependent impedance analyzer, a biological entity impedance value of a single biological entity in a biological entities population, said biological entity impedance value comprising an impedance amplitude and an impedance phase;
comparing said biological entity impedance value to the biological entity impedance value of a standard reference biological entity or biological entities population; and
graphically or numerically providing a read-out of said comparison.

19. The system of claim 18, wherein said frequency-dependent impedance analyzer is a frequency-dependent impedance flow cytometer.

20. The system of claim 18, wherein frequency-dependent impedance analyzer is configured to operate at at least one frequency comprised between 10 kHz and 20 MHz, such as between 50 kHz and 10 MHz.

21. The system of claim 18, wherein the processor comprises instructions to perform a biological entity impedance value estimation of said single biological entity by calculating the ratio Re(Z) at f1/Re(Z) at f2, Re(Z) being defined as the real part of the impedance vector, and f1 and f2 being two frequencies wherein f1 is bigger than f2.

22. The system of claim 19, wherein the flow cytometer is configured to isolate or to sort said single biological entity through a Coulter principle-based impedance means.
